(19) United States
(12) Patent Application Publication
(10) Pub. No.: US 2008/0315574 A1
(43) Pub. Date: Dec. 25, 2008

(54) Security Feature for Security Documents

(75) Inventors: Markus Emerich, Wien (AT); Franz Loos, Wein (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: OESTERREICHISCHE BANKNOTEN-UND SICHERHEITSDRUCK GMBH, 1096 Wien (AT)

(21) Appl. No.: 11/575,265

(22) PCT Filed: Sep. 13, 2005
(86) PCT No.: PCT/AT2005/000366

§ 371 Date: Aug. 22, 2008

(30) Foreign Application Priority Data
Sep. 14, 2004 (AT) A 1537/2004

(51) Int. Cl. B42D 15/10; B41M 3/14

(52) U.S. Cl. 283/91; 283/94; 283/114

(57) ABSTRACT

The invention relates to a security feature (8) for security documents (9), in particular bank notes. A first body colour (51) is applied in a first region (1) and a printing ink (53), in particular a day luminescent dye, is applied in an illuminating region (3). The printing ink (53) is applied outside the copy dye range of the four colour prints according to the Europe-scale or DIN-scale. According to the invention, a first mixed colour (54) of the first body colour (51) and the printing ink (53) is applied in a first overlapping region (13), and the first mixed colour (54) is arranged outside the copy dye range or in the edge region of the copy dye range, in order to increase protection against forgery.

The invention relates to a security feature for security documents, especially bank notes, with a first body color being applied in a first region and a printing ink, especially a day luminescent dye, being applied in an illuminating region, with the printing ink being applied outside the copy dye range of the four color print according to the Europe scale or DIN scale.

It is known to provide security documents with security features which should make counterfeiting more difficult and which can be used for checking the authenticity of the security document. A forged document can be produced especially easily by means of a color copying machine. The differences of these forged documents as compared with the original have become smaller due to the increased resolution and an improved color formulation of color copying machines and therefore the provision of new security features is desirable which cannot be reproduced by means of conventional color copying machines.

It is known from EP 0 603 117 to use printing inks for printing colors which differ as strongly as possible from the toners used in conventional color copying machines, as a result of which a difference in color is achieved between the original and the color copy. The use of fluorescence effect colorants is also proposed. The disadvantageous aspect is that this security feature is not suitable for evaluation by everybody because a comparison with an original security document is necessary for securely determining a forged document. When the difference in color only occurs through a certain type of illumination, then the production of this type of illumination can often only be achieved with much effort.

It is the object of the present invention to provide security features of the kind mentioned above in which the known disadvantages are avoided and which have a high amount of security against forgery, especially concerning color copying machines or scanners. It is a further object of the invention to help color-blind persons to recognize forged documents too.

This is achieved in accordance with the invention in such a way that a first mixed color of the first body color and the printing ink is applied in a first overlapping region, and that the first mixed color is arranged outside of the copy dye range or in the edge region of the copy dye range.

This leads to the advantage that the first region, the first overlapping region and the illuminating region are formed in a distinguishable manner on the original security feature. In color copies, however, the printing ink cannot be reproduced in an authentic manner and the first overlapping region and the illuminating region in the color copy are formed to coincide. A differentiation of these areas can only be achieved through a strong color distortion of the color copy which also affects the remaining areas. A color copy can thus be distinguished very easily from an original security feature. The fluorescence of the printing ink further represents a further security feature. The different luminous intensity of the illuminating region and the first overlapping region can be used by illumination with UV light for verifying the authenticity of the security feature.

It can be provided for in a further development of the invention that the first overlapping region is arranged adjacent to the first region and adjacent to the illuminating region, as a result of which the detection of differences in color is facilitated in these regions.

According to a further embodiment of the invention it can be provided that in the case of a color copy by means of a copying machine with basic setting the printing ink and the first mixed color are reproduced with a color difference evaluation Delta E of less than 3, preferably less than 2, more preferably less than 1. In the basic setting, the average deviation of colors in the copy dye range with the colors on the color copy is as low as possible. It can thus be ensured that in the case of a color copy with basic setting the formation of the printing ink and the first mixed color coincide as far as possible, as a result of which a color copy can easily be detected as a forgery as a result of the missing contrast.

In a further embodiment of the invention it can be provided that the maximum of the reflection curve of the first mixed color is higher than the maximum of the reflection curve of the first body color. A high security from copying of the security feature can thus be achieved.

In a further development of the invention it can be provided that the intensity of the reflection curve of the first mixed color at maximum is higher than 90%, preferably higher than 95%, more preferably higher than 100%. It can be ensured in such intensities that fluorescent properties of the printing ink will also occur in the first mixed color.

According to another embodiment of the invention it can be provided that in a second region a second body color is applied and that in a second overlapping region a second mixed color of the second body color and the printing ink is formed, and that the second mixed color is situated outside of the copy dye range. The security from copying of the security feature in accordance with the invention can be increased even further by providing the second mixed color.

In this connection it can be provided in a further embodiment of the invention that the second overlapping region is arranged adjacent to the second region and adjacent to the illuminating region, as a result of which differences in the colors in the various regions can be detected in an especially simple way.

According to a further embodiment of the invention it can be provided that in the case of a color copy made by means of a copying machine with basic setting the printing ink and the second mixed color are reproduced with a color difference evaluation Delta E of less than 3, preferably less than 2, more preferably less than 1. It can be ensured in this way that in the case of a color copy with basic setting the formulation of the printing ink and the second mixed color will coincide substantially, as a result of which a color copy can be detected easily as a forgery as a result of the lack of contrast.

In a further embodiment of the invention it can be provided that the maximum of the reflection curve of the second mixed color is higher than the maximum of the reflection curve of the second body color. A high security from copying the security feature can thus be achieved.

It can be provided in a further development of the invention that the intensity of the reflection curve of the second mixed color at the maximum is higher than 90%, preferably higher than 95%, and more preferably higher than 100%. It can be ensured in such intensities that fluorescent properties of the printing ink will also occur in the first mixed color.

According to another embodiment of the invention it can be provided that one of the body colors has a higher share in a first primary color and a lower share in a second primary color than the other of the body colors, with the share in the third primary color being smaller than the share of the first primary color and the second primary color in the printing ink and with the first primary color, the second primary color and the third primary color being chosen from the quantity of the primary colors of red, green and blue. As a result, the recognition of the authenticity of the security feature can also be facilitated for color-blind persons, e.g. for persons with red-green blindness when using a yellow printing ink. Furthermore, even in the case of a possible change of the settings of a copying machine a different formulation for the first overlapping region, the illuminating region and the second overlapping region can be avoided, so that a color copy can easily be detected as a forgery.

One variant of the invention can be that the first body color is substantially a complementary color of the second body color. By using complementary colors it is possible to achieve an especially high security from copying because a change in the settings of the color copying machine has a different effect on the body colors and any enhancement of the contrast of the first mixed color with the printing ink leads to a deterioration in the contrast of the second mixed color with the printing ink.

The invention further relates to a security document, especially a bank note.

It is the object of the present invention to provide a security document of the kind mentioned above in which the known disadvantages are avoided and offers a high amount of security against forgery in respect of color copies.

The invention is now explained in closer detail by reference to the enclosed drawings showing embodiments, wherein:

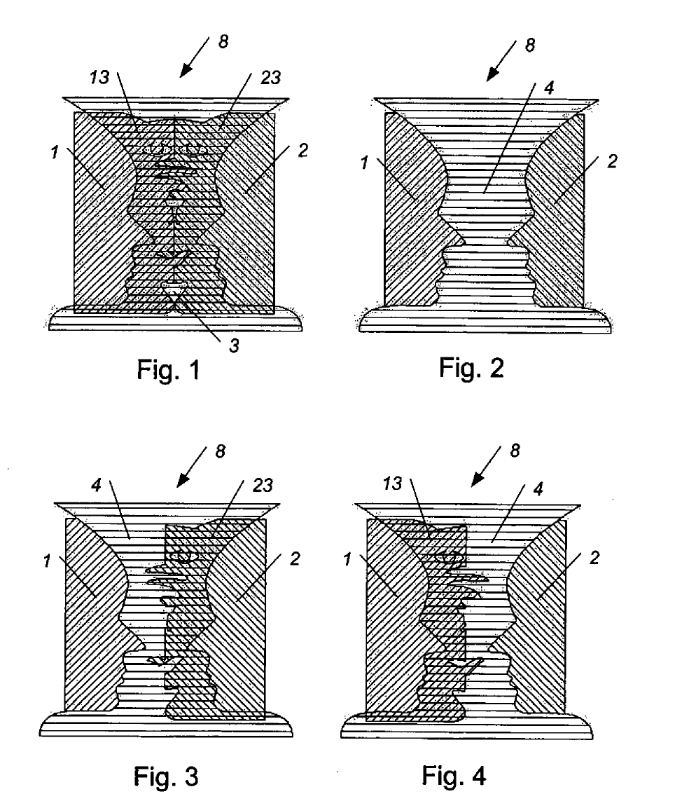

FIG. 1 shows an embodiment of a security feature in accordance with the invention;

FIG. 2 shows a color copy of the security feature in accordance with FIG. 1 with basic setting of the color copying machine;

FIG. 3 shows a color copy of the security feature according to FIG. 1 when setting the color copying machine to cold colors;

FIG. 4 shows a color copy of the security feature according to FIG. 1 when setting the color copying machine to warm colors;

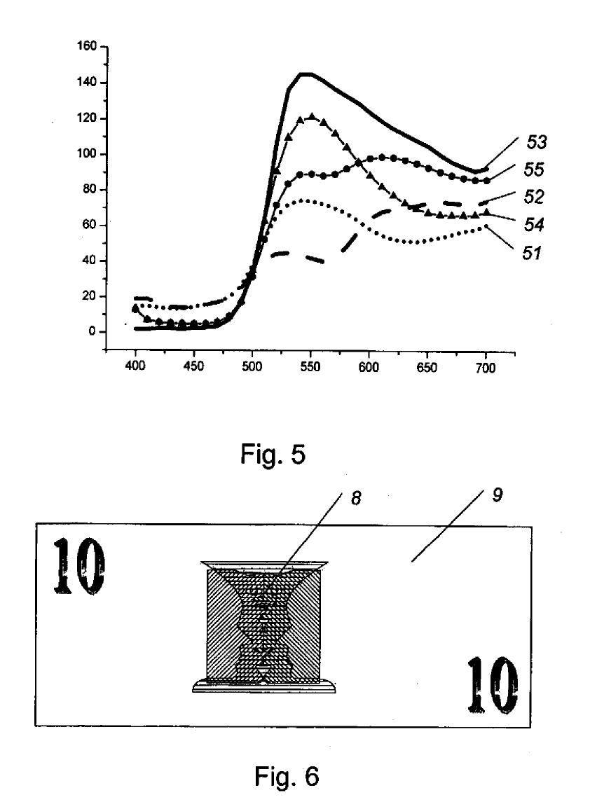

FIG. 5 shows the reflection curves in the visible range of the colors of the security feature according to FIG. 1, and

FIG. 6 shows a security document according to the invention.

FIG. 1 shows an embodiment of a security feature 8 in accordance with the invention for security documents 9. The security document 9 can especially be a bank note, as shown in FIG. 6. In other embodiments the security document can also be a security paper, a document, a contract or any other security document. The security feature 8 comprises a first body color 51 in a first region 1 and a printing ink 53 in an illuminating region 3, with the printing ink 53 being arranged outside of the copy dye range of four-color print according to Europe scale or DIN scale. The body color 51 can be a primary color or even a formulation of different colors. Similarly, the printing ink 53 can be arranged as a formulation of different colors.

The copy dye range is obtained from the colors used in four-color printing and is specified with respect to the Europe scale in DIN 16538 and DIN 165309 and concerning the DIN scale in DIN 16508 and DIN 16509.

The printing ink 53 can especially be a day luminescent dye. Day luminescent dyes are fluorescent colors which shine intensively in the visible range of the spectrum under ultraviolet radiation. These colors also exploit the ultraviolet rays of daylight in addition to the visible range, with the day luminescent dyes belonging to the most brilliant of all colors by this double color effect. In other embodiments the printing ink 53 can comprise special-effect colors. Interference pigments, liquid-crystalline colors or nacreous pigments can be provided in particular. The printing ink 53 can also be a formulation of day luminescent dyes and special-effect colors.

The CIELab system is understood as the dye range and the color difference in the CIELab system is understood as the color difference evaluation. The copy dye range is thus the color dye range in the CIELab system which is determined for four-color printing by the colors determined in the Europe scale or DIN scale. The colors of a color copy are produced by subtractive color mixing.

A first mixed color 54 of the first body color 51 and the printing ink 53 is formed in a first overlapping region 13, with the first mixed color 54 being arranged outside of the copy dye range or in the edge region of the copy dye range.

The overlapping region 13 and the first mixed color can easily be formed in such a way that a part of the first body color 51 is printed over with the printing ink 53. In other embodiments, the printing ink 53 can be printed over with the first body color 51 or the first mixing color 54 can be printed directly. It appears to be advantageous when the first overlapping region 13 is arranged adjacent to the first region 1 and the illuminating region 3, as a result of which differences in the color of these regions can be determined easily.

Favorable copy protection can be achieved when the printing ink 53 differs from the first mixed color 54 on the original, when the printing ink 53 and the first mixed color 54 are reproduced in a color copy by means of a copying machine with basic setting with a color difference evaluation of Delta E of less than 3, preferably less than 2, and more preferably less than 1. Basic setting shall be understood as the standard setting of a color copying machine in which the average deviation of colors in the color dye range with the colors on the color copy is as low as possible.

In addition to this basic setting, the copying machines can usually also be set to the setting “cold” and “warm” where an additional weighting of the colors can be made concerning the formulation.

FIG. 5 shows the reflection curves in the visible range of the colors of the security feature 8. A substantially similar formulation of the printing ink 53 and the first mixed color 54 can be achieved in a simple way when the intensity of the first body color 51 is substantially beneath the intensity of the printing ink 53 in the visible range. It has been noticed that slightly exceeding in ranges of low intensity has proven to be irrelevant.

It seems to be relevant as a criterion that the maximum of the reflection curve of the first mixed color 54 is higher than the maximum of the reflection curve of the first body color 51. It has further proven to be advantageous when the intensity of the reflection curve of the first mixed color 54 is higher than 90% at maximum, preferably higher than 95% and more preferably higher than 100%. The high intensities can be achieved as a result of the fluorescent properties of the printing ink 53.

The reliability of the security feature 8 can be increased when a second body color 52 is applied in a second region 2 and in a second overlapping region 23 a second mixed color 55 of the second body color 52 and the printing ink 53, with the second mixed color being arranged outside of the copy dye range.

The second mixed color 55 can be produced easily by printing over a portion of the second body color 52 with the printing ink 53. It appears to be advantageous when the second overlapping region 23 is arranged adjacent to the second region 2 and adjacent to the illuminating region 3.

The explanations made for the second body color 52 and the second mixed color 55 apply in an analogous manner to first body color 51 and the first mixed color 54. It appears to be especially advantageous when the intensity of the second body color 52 is substantially beneath the intensity of the printing ink 53 in the visible range. It has been noticed that slightly exceeding in ranges of low intensity has proven to be irrelevant.

Favorable copy protection can be achieved when in the case of a color copy by means of a copying machine with basic setting the printing ink 53 and the second mixed color 55 are reproduced with a color difference evaluation Delta E of less than 3, preferably less than 2, more preferably less than 1.

The maximum of the reflection curve of the second mixed color 55 shall be higher than the maximum of the reflection curve of the second body color 52. It has further been seen that it is appropriate when the intensity of the reflection curve of the second mixed color 55 at maximum is higher than 90%, preferably higher than 95%, especially higher than 100%. These high intensities can be achieved in a simple way especially when using day luminescent dyes as a printing ink 53 due to the fluorescent properties.

An especially favorable copy protection is obtained when the first body color 51 is substantially a complementary color of the second body color 52. The security feature can thus not be reproduced in such a way, even when changing the settings of the copying machine, that the color copy is not recognized immediately as a color copy. When a setting is chosen which amplifies the contrast between one of the mixed colors 54, 55 and the printing ink 53, the contrast between the printing ink 53 and the other of the mixed colors 54, 55 is reduced in this setting.

It has been seen that favorable results are also achieved when one of the body colors 51, 52 has a higher share of a first primary color and a lower share of a second primary color than the other of the body colors 51, 52. In the printing ink 53, the share of the third primary color is smaller than the share of the first primary color and the second primary color and the first primary color, second primary color and third primary color are chosen from the quantity of the primary colors red, green and blue. When using a printing ink 53 with a high share of red and green (e.g. a yellow day luminescent dye), this is the case when one of the body colors 51, 52 has a higher share in green and a lower share in red than the other of the body colors 51, 52.

In the case of a color copy of a security feature in accordance with the invention it can be achieved that the first overlapping region 13, the illuminating region 3 and optionally the second overlapping region 23 appear in the color copy as a unified region 4. A human eye with normal eyesight can distinguish the illuminating region 3 from the first overlapping region 13 and the second overlapping region 23 on an original security feature 8. If this differentiation is not possible by the formation of the unified region 4, the color copy can be recognized easily and quickly as a forgery. Such a color copy is shown schematically in FIG. 2.

By changing the settings of the color copying machine it is possible to change the weighting of the colors, as a result of which the first overlapping region 13 and the second overlapping region 23 can be made visible. The change of the weighting of the colors also changes the reproduction of all other colors of the security document 9 on the color copy, leading to the consequence that the color copy appears unnatural and can thus also be recognized as a forgery in a simple and quick manner. FIG. 3 schematically shows a color copy in which the cold colors are emphasized and FIG. 4 shows a color copy in which the warm colors are emphasized. It has been noticed that in the case of a sufficient distance of the two body colors 51, 52 it is not possible, even when changing the settings of the color copying machine, to copy the overlapping region 13, the second overlapping region 23 and the illuminating region 3 in such a way that these regions remain distinguishable for the human eye on the color copy.

Even color-blind persons who are capable of distinguishing at least the first overlapping region 13 or the second overlapping region 23 of the illuminating region 3 and for whom it is sufficient when they are capable of seeing them as different tones of grey can distinguish a color copy from an original security document 9 by means of the security feature in accordance with the invention.

A further advantage of the security feature 8 is that when using a day luminescent dye as a printing ink 53, the same will represent an additional security feature as a result of its fluorescent properties. The fluorescence is activated differently strong in the illuminating region 3, the first overlapping region 13 and the second overlapping region 23, so that an additional security feature is formed by the different intensity.

Indirect relief printing or wet offset printing seem to be especially suitable for applying the body colors 51, 52, and especially screen-printing, gravure printing or flexographic printing for applying the printing ink 3.

The advantages of the security feature 8 also occur when making a printout after prior scanning.

1.-13. (canceled)

14. A security feature for security documents, especially bank notes, with a first body color being applied in a first region and a printing ink being applied in an illuminating region, with the printing ink (53) being applied outside a copy dye range of a four color print according to the Europe scale or DIN scale, wherein a first mixed color of the first body color and the printing ink is applied in a first overlapping region, said first mixed color being arranged outside of the copy dye range or in an edge region of the copy dye range.

15. The security feature of claim 14, wherein the printing ink is a day luminescent dye.

16. The security feature of claim 14, wherein the first overlapping region is arranged adjacent to the first region and adjacent to the illuminating region.

17. The security feature of claim 14, wherein in a reproduction in the copy dye range in which the average deviation of colors in the copy dye range from the colors on the color copy is as low as possible, the reproduction of the printing ink and the reproduction of the first mixed color has a color difference evaluation Delta E of less than 3.

18. The security feature of claim 17, wherein the color difference evaluation Delta E is less than 2.

19. The security feature of claim 17, wherein the color difference evaluation Delta E is less than 1.

20. The security feature of claim 14, wherein the first mixed color has a maximum of a reflection curve which is higher than a maximum of a reflection curve of the first body color.

21. The security feature of claim 20, wherein the reflection curve of the first mixed color has a maximum intensity which is higher than 90%.

22. The security feature of claim 20, wherein the reflection curve of the first mixed color has a maximum intensity which is higher than 95%.

23. The security feature of claim 20, wherein the reflection curve of the first mixed color has a maximum intensity which is higher than 100%.

24. The security feature of claim 14, wherein a second body color is applied in a second region, and a second mixed color of the second body color and the printing ink is formed in a second overlapping region, wherein the second mixed color is situated outside of the copy dye range.

25. The security feature of claim 24, wherein the second overlapping region is arranged adjacent to the second region and adjacent to the illuminating region.

26. The security feature of claim 24, wherein in a reproduction in a copy dye range in which an average deviation of colors in the copy dye range from the colors on the color copy is as low as possible, the reproduction of the printing ink and the reproduction of the second mixed color has a color difference evaluation Delta E of less than 3.

27. The security feature of claim 26, wherein the color difference evaluation Delta E of less than 2.

28. The security feature of claim 26, wherein the color difference evaluation Delta E of less than 1.

29. The security feature of claim 24, wherein the second mixed color has a maximum of a reflection curve which is higher than a maximum of a reflection curve of the second body color.

30. The security feature of claim 29, wherein the reflection curve of the second mixed color has a maximum intensity which is higher than 90%.

31. The security feature of claim 29, wherein the reflection curve of the second mixed color has a maximum intensity which is higher than 95%.

32. The security feature of claim 29, wherein the reflection curve of the second mixed color has a maximum intensity which is higher than 100%.

33. The security feature of claim 24, wherein one of the body colors has a higher share of a first primary color and a lower share of a second primary color than the other one of the body colors, with the share of a third primary color being smaller than the share of the first primary color and the second primary color in the printing ink, and with the first primary color, the second primary color and the third primary color being chosen from a quantity of the primary colors of red, green and blue.

34. The security feature of claim 24, wherein the first body color is substantially a complementary color of the second body color.

35. A security document, especially a bank note, comprising a security feature as set forth in claim 14.
